(19) United States
(12) Patent Application Publication
(10) Pub. No.: US 2017/0287049 A1
(43) Pub. Date: Oct. 5, 2017

(54) COORDINATED TRANSPORT OF GOODS

(71) Applicant: International Business Machines Corporation, Armonk, NY (US)

(72) Inventors: Jialin Li, Westford, MA (US); Pradeep K. Nanjundaswamy, Bangalore (IN)

(21) Appl. No.: 15/090,676

(22) Filed: Apr. 5, 2016

(51) Int. Cl. G06Q 30/06; G06Q 10/08

(52) U.S. Cl. CPC G06Q 30/0633; G06Q 10/08

(57) ABSTRACT

A computer-implemented method includes identifying a return item associated with a return item location; identifying a first profile associated with the return item and a social return availability database; and determining one or more return suggestions based on the return item location and one or more additional profiles of the social return availability database. The one or one or more return suggestions suggest returning the return item by the one or more additional profiles. The computer-implemented method further includes presenting, to the first profile, the one or more return suggestions. A corresponding computer program product and computer system are also disclosed.

### BACKGROUND

The present invention relates generally to the field of order management systems, and more particularly to enhancing user experience in such systems.

Order management systems typically will determine options for transportation of goods. In such order management systems, the costs associated with such transportation options may impose a substantial burden on users of such systems. The cost associated with a determined transportation option can be an important consideration in the quality of user experience enjoyed by users of an order management system. The developers and users of order management systems continue to face challenges with reducing transportation costs in such systems.

### SUMMARY

A computer-implemented method includes identifying a return item associated with a return item location; identifying a first profile associated with the return item and a social return availability database; and determining one or more return suggestions based on the return item location and one or more additional profiles of the social return availability database. The one or one or more return suggestions suggest returning the return item by the one or more additional profiles. The computer-implemented method further includes presenting, to the first profile, the one or more return suggestions. A corresponding computer program product and computer system are also disclosed.

### BRIEF DESCRIPTION OF THE DRAWINGS

FIG. 1 is a block diagram of one embodiment of a computer system environment suitable for operation of a return suggestion determination program, in accordance with at least one embodiment of the present invention.

FIG. 2 is a data-flow diagram of a return suggestion determination program, in accordance with at least one embodiment of the present invention.

FIG. 3 is a flow-chart diagram of a return suggestion determination program, in accordance with at least one embodiment of the present invention.

FIG. 4 is a block diagram of a computing apparatus suitable for executing a return suggestion determination program, in accordance with at least one embodiment of the present invention.

### DETAILED DESCRIPTION

Aspects of the present invention are directed to an omnichannel approach to sale of goods in multichannel sales platforms (i.e., sales platforms in which goods are sold through different channels, such as an online channel, a telephone-based channel, and a physical store channel). In such multichannel sales platforms, an omnichannel approach seeks to provide a customer with a seamless shopping experience regardless of the channel used by the customer (e.g., whether the customer is shopping online from a desktop or mobile device, by telephone, or in a physical store). With the omnichannel approach to sales, a customer can buy goods online and chose to return the purchased goods by visiting a store and/or buy goods online and chose to pick up the purchased goods by visiting a store.

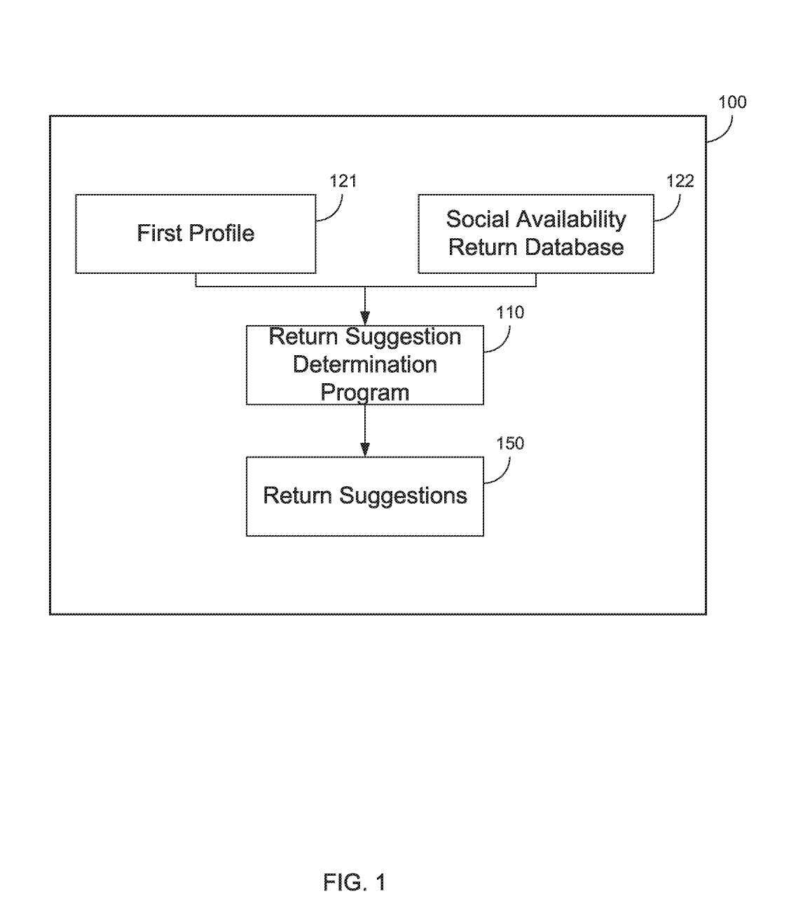

FIG. 1 is a block diagram of a computer system environment 100 suitable for operating a return suggestion determination program 110, in accordance with at least one embodiment of the present invention. In the computer system environment 100 depicted in FIG. 1, the program 110 communicates with and/or uses a first profile 121 and a social return availability database 122 to determine one or more return suggestions 150. In at least some embodiments, a first profile 121 is any collection of one or more information artefacts about at least one return requesting user. In at least some embodiments, a return requesting user is a computer user requesting one or more return suggestions 150 (e.g., for the return of at least one return item to at least one final return location). In at least some embodiments, a final return location associated with at least one return item is a location to which the at least one return item must be turned into (with or without the use of intermediary actors other than the return requesting user) for the return of the at least one return item to be deemed successful and/or acceptable. In at least embodiments, a return item is any item that at least one first profile 121 and/or at least one return requesting user indicates needs to be returned using the program 110.

In the computer system environment 100 depicted in FIG. 1, a social return availability database 122 is any collection of one or more information artefacts about social media connections of one or more user profiles (e.g., the at least one first profile 121 and/or one or more additional profiles associated and/or connected with the at least one first profile 121 through at least one social media application and/or platform) as well as one or more information artefacts about requests, desires, decisions, and/or intentions of the one or more user profiles for visiting at least one return location, such as at least one final return location (e.g., for returning at least one return item to at least one final return location, picking up an item from at least one final return location, and/or causing at least one return item to be delivered to at least one delivery destination location other than the at least one final return location). In at least some embodiments, a return suggestion 150 is an indication of at least one suggestion and/or recommendation to cause at least one return item to be delivered to at least one delivery destination location (such as at least one final return location).

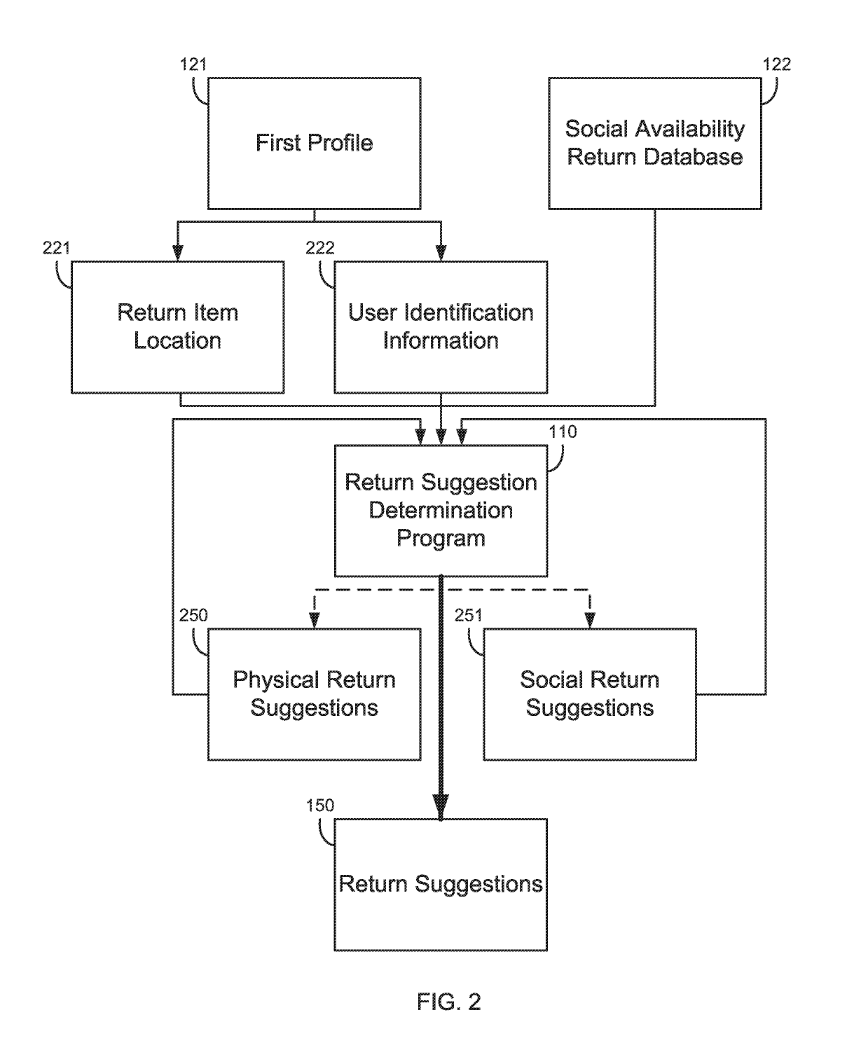

FIG. 2 is a data flow diagram of a return suggestion determination program 110, in accordance with at least one embodiment of the present invention. In the embodiment depicted in FIG. 2, the program 110 receives at least one return item location 221 and one or more user identification information artefacts 222 from the first profile 121. In at least some embodiments, a return item location 221 associated with a return item is a physical location (e.g., a physical address and/or geographical coordinate location) determined to be associated with a return item (e.g., with a pre-defined level of certainty, such as 99% certainty) at a time determined (e.g., based on at least one input by the return requesting user associated with the first profile 121 and/or one or more predefined rules of the program 110) by the program 110 (e.g., a time agreed upon by the program 110 and the return requesting user associated with the first profile 121, such as the time the request for return is made or an agreed-upon time for pick-up and/or delivery initiation). In at least some embodiments, a user identification information artefact 222 is any information artefact derived (directly or indirectly) from at least one first profile 121 that can (individually or along with one or more other information artefacts, such as one or more user identification information artefacts 222) be used to determine at least one social media connection of the return requesting user associated with the first profile 121 based on the social return availability database 122 and/or determine whether the return requesting user associated with the first profile 121 has any social media connections that can be determined based on the social return availability database 122.

In the embodiment depicted in FIG. 2, the return suggestion determination program 110 uses the at least one return item location 221 and the one or more user identification information artefacts 222 to determine at least one physical return suggestion 250 and at least one social return suggestion 251. In at least some embodiments, a physical return suggestion 250 is a return suggestion 150 with regard to which every associated one or more delivery destination location is a final return location. In at least some embodiments, a social return suggestion 251 is a return suggestion 150 with regard to which every associated one or more delivery destination location is a delivery destination location other than a final return location. In at least some embodiments, the program 110 uses the social return availability database 122 to determine the delivery path from a delivery destination location associated with a social return suggestion 251 to a final return location. In at least some embodiments, the program 110 uses the at least one physical return suggestion 250 and the at least one social return suggestion 251 (e.g., by comparing and contrasting one or more metrics associated with the at least one physical return suggestion 250 and the at least one social return suggestion 251, such as the estimated distance and/or travel time associated with at least one of the two) to determine at least one return suggestion 150.

In some embodiments, a delivery destination location associated with a return suggestion 150 is a return item location associated with at least one return item with regard to which the return suggestion 150 is determined. In some of those embodiments, the return requesting user associated with a first profile 121 does not have to drop the return item at any place other than a return item location determined in relation to the return item. In some of those embodiments, a social media connection (e.g., a user associated with at least one additional profile determined based on the social return availability database 122) is indicated to be able to receive the return item in the return item location. In some of those embodiments, a social media connection is indicated to be able to pick up the return item from the return item location.

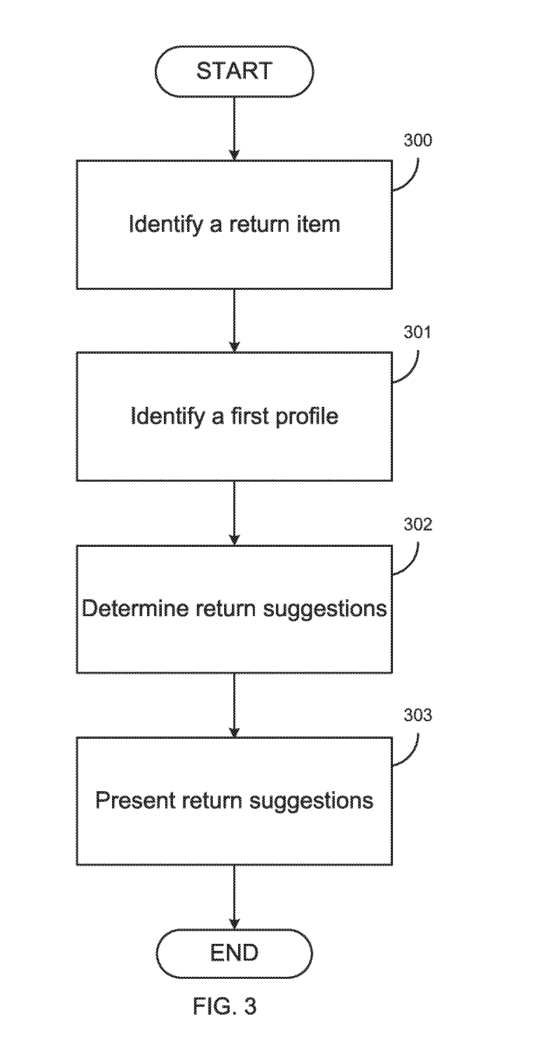

FIG. 3 is a flow-chart diagram of a return suggestion determination program, in accordance with at least one embodiment of the present invention. At step 300, the program identifies a return item associated with a return item location. At step 301, the program identifies a first profile associated with the return item and a social return availability database. At step 302, the program determines one or more return suggestions based on the return item location and one or more additional profiles of the social return availability database, wherein the one or more return suggestions suggest returning the return item by the one or more additional profiles. At step 303, the program presents to the first profile the one or more return suggestions.

In some embodiments, the one or more additional profiles indicate that at least one of the one or more additional profiles is designated as returning at least one item to at least one final return location, picking up at least one item at the at least one final return location and/or otherwise visiting the at least one final return location. In some embodiments, identifying the return item comprises receiving a return request. In at least some embodiments, a return request is any indication of a request for returning at least one return item associated with at least one return item location by at least one user associated with the first profile.

In some embodiments, the one or more return suggestions comprise one or more delivery options selected from the group consisting of: (i) one or more social return suggestions; and (ii) one or more physical return suggestions. In some of those embodiments, the return suggestion determination program further comprises: (i) for each of the one or more return suggestions, determining a cost value; and (ii) for each social return suggestion of the one or more social return suggestions, determining whether the cost value is lower than the cost value associated with all of the one or more physical return suggestions. In at least some of those embodiments, presenting the one or more return suggestions comprises, for each social return suggestion of the one or more social return suggestions, responsive to the cost value being lower than the value associated with all of the one or more physical return suggestions, presenting, to the first profile, the social return suggestion. In at least some of those embodiments, the program presents a social return suggestion to the first profile only if the cost value associated with that social return suggestion is lower than the cost value associated with all of the one or more physical return suggestions.

In at least some embodiments, a cost value associated with a return suggestion is any estimated and/or determined measure of the time, energy, and/or monetary cost that the return suggestion imposes on a return requesting user associated with the first profile based on the return item location (e.g., the travel time to at least one delivery destination location contemplated by the return suggestion and/or the monetary cost of travel to the at least one delivery location using public transportation based on one or more information artefacts about the public transportation system).

In some embodiments, the return suggestion determination program further comprises determining a social relationship database and determining a return availability database (e.g., an order management system, such as IBM®'s Sterling Order Management software). In at least some of those embodiments, the social return availability database is determined based on the social relationship database and a return availability database (e.g., by joining the two databases). In at least some embodiments, a social relationship database is any collection of one or more information artefacts about social media connections of one or more user profiles (e.g., the first profile and the one or more additional profiles). In at least some embodiments, a return availability database is any collection of one or more information artefacts about requests, desires, decisions, and/or intentions of the one or more user profiles for visiting at least one return location, such as at least one final return location (e.g., for returning at least one return item to at least one final return location, picking up an item from at least one final return location, and/or causing at least one return item to be delivered to at least one delivery destination location other than the at least one final return location).

In some embodiments, the return suggestion determination program further comprises identifying a selected return suggestion and creating a reference to the selected return suggestion in the return availability database. In at least some of those embodiments, a selected return suggestion is a return suggestion with regard to which the program determines and/or receives an indication of acceptance and/or selection from the first profile or at least one computer user associated with the first profile. In at least some embodiments, determining the social relationship database further comprises accessing at least one social networking application programming interface. In at least some embodiments, a social networking application programming interface is any software framework that allows for the retrieval of one or more information artefacts and/or one or more services from at least one social media application and/or platform.

In at least some embodiments, a user causes an indication to be transmitted to a return suggestion determination program that the user intends to return at least one product to at least one final return location. The program determines whether at least one social media connection (such as one or more of a Facebook friend, a Twitter follower, an Instagram follower, etc.) associated with the user intends to visit the at least one final return location. The program determines suggestions for returning the product through the help of one or more of the at least one social media connection. In at least some embodiments, determining the social return availability database comprises determining whether at least one social media connection (such as one or more of a Facebook friend, a Twitter follower, an Instagram follower, etc.) associated with the user intends to visit the at least one final return location.

In general, one or more steps associated with different embodiments of the return suggestion determination program may be performed based on one or more pieces of information obtained directly or indirectly from one or more computer (hardware or software) components, one or more pieces of information obtained directly or indirectly from one or more inputs from one or more users, and/or one or more observed behaviors associated with one or more (hardware or software) components of one or more computer system environments. In general, one or more steps of different embodiments of the return suggestion determination program may comprise communicating with one or more computer (hardware or software) components, issuing one or more computer instructions (e.g., one or more special purpose machine-level instructions defined in the instruction set of one or more computer hardware components), and/or communicating with one or more computer components at the hardware level.

Aspects of the present invention enable the enhancement of options for returning items and coordinated transport of goods using social media connections of users. The inventors recognized the problem of excessive costs associated with return of items and transport of goods and found that social media connections can effectively be used to reduce those costs and minimize the need for independent delivery and transport of goods. Nevertheless, the aforementioned advantages are not required to be present in all of the embodiments of the invention and may not be present in all of the embodiments of the invention.

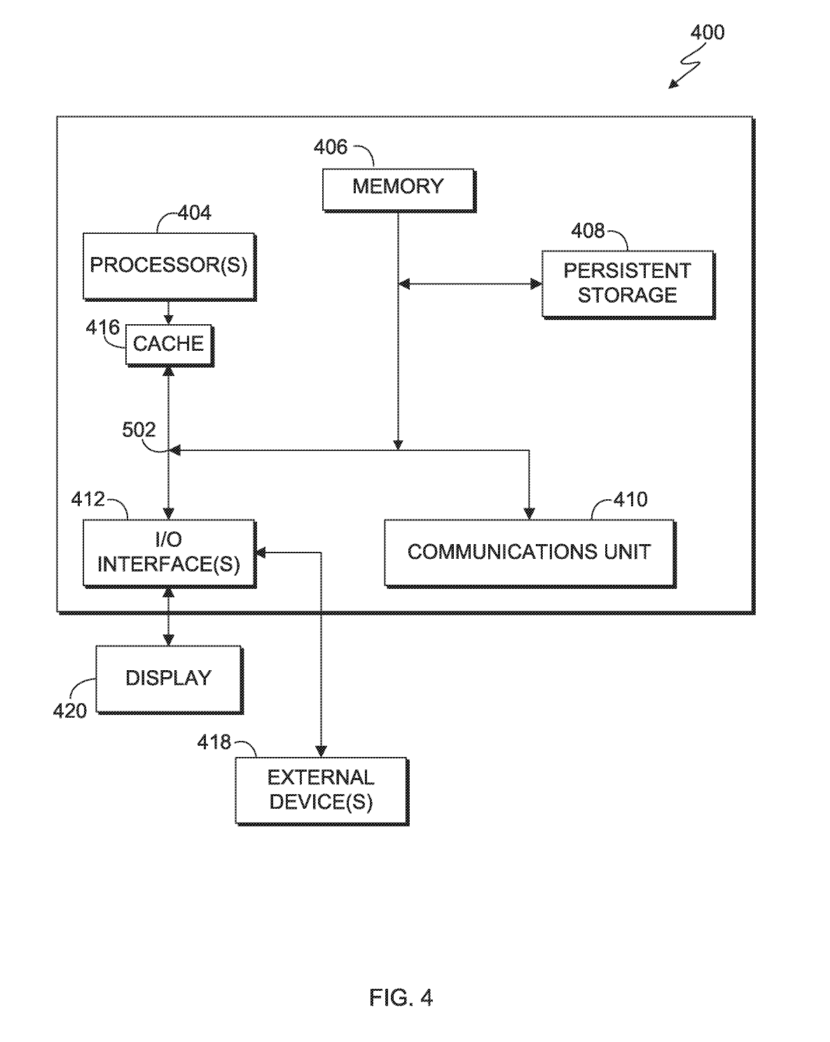

FIG. 4 is a block diagram depicting components of a computer 400 suitable for executing a return suggestion determination program. FIG. 4 displays the computer 400, the one or more processor(s) 404 (including one or more computer processors), the communications fabric 402, the memory 406, the RAM, the cache 416, the persistent storage 408, the communications unit 410, the I/O interfaces 412, the display 420, and the external devices 418. It should be appreciated that FIG. 4 provides only an illustration of one embodiment and does not imply any limitations with regard to the environments in which different embodiments may be implemented. Many modifications to the depicted environment may be made.

As depicted, the computer 400 operates over a communications fabric 402, which provides communications between the cache 416, the computer processor(s) 404, the memory 406, the persistent storage 408, the communications unit 410, and the input/output (I/O) interface(s) 412. The communications fabric 402 may be implemented with any architecture suitable for passing data and/or control information between the processors 404 (e.g., microprocessors, communications processors, and network processors, etc.), the memory 406, the external devices 418, and any other hardware components within a system. For example, the communications fabric 402 may be implemented with one or more buses or a crossbar switch.

The memory 406 and persistent storage 408 are computer readable storage media. In the depicted embodiment, the memory 406 includes a random access memory (RAM). In general, the memory 406 may include any suitable volatile or non-volatile implementations of one or more computer readable storage media. The cache 416 is a fast memory that enhances the performance of computer processor(s) 404 by holding recently accessed data, and data near accessed data, from memory 406.

Program instructions for the return suggestion determination program may be stored in the persistent storage 408 or in memory 406, or more generally, any computer readable storage media, for execution by one or more of the respective computer processors 404 via the cache 416. The persistent storage 408 may include a magnetic hard disk drive. Alternatively, or in addition to a magnetic hard disk drive, the persistent storage 408 may include, a solid state hard disk drive, a semiconductor storage device, read-only memory (ROM), electronically erasable programmable read-only memory (EEPROM), flash memory, or any other computer readable storage media that is capable of storing program instructions or digital information.

The media used by the persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of the persistent storage 408.

The communications unit 410, in these examples, provides for communications with other data processing systems or devices. In these examples, the communications unit 410 may include one or more network interface cards. The communications unit 410 may provide communications through the use of either or both physical and wireless communications links. The return suggestion determination program may be downloaded to the persistent storage 408 through the communications unit 410. In the context of some embodiments of the present invention, the source of the various input data may be physically remote to the computer 400 such that the input data may be received and the output similarly transmitted via the communications unit 410.

The I/O interface(s) 412 allows for input and output of data with other devices that may operate in conjunction with the computer 400. For example, the I/O interface 412 may provide a connection to the external devices 418, which may include a keyboard, keypad, a touch screen, and/or some other suitable input devices. External devices 418 may also include portable computer readable storage media, for example, thumb drives, portable optical or magnetic disks, and memory cards. Software and data used to practice embodiments of the present invention may be stored on such portable computer readable storage media and may be loaded onto the persistent storage 408 via the I/O interface(s) 412. The I/O interface(s) 412 may similarly connect to a display 420. The display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
identifying a return item, said return item being associated with a return item location;
identifying a first profile, said first profile being associated with said return item and a social return availability database;
determining one or more return suggestions based on said return item location and one or more additional profiles of said social return availability database, wherein said one or more return suggestions suggest returning said return item by said one or more additional profiles; and
presenting, to said first profile, said one or more return suggestions.

2. The computer-implemented method of claim 1, wherein identifying said return item comprises:
receiving a return request.

3. The computer-implemented method of claim 1, wherein said one or more return suggestions comprise one or more delivery options selected from the group consisting of:
one or more social return suggestions; and
one or more physical return suggestions.

4. The computer-implemented method of claim 3, further comprising:
for each of said one or more return suggestions, determining a cost value; and
for each social return suggestion of said one or more social return suggestions, determining whether said cost value is lower than said cost value associated with all of said one or more physical return suggestions; and
wherein presenting said one or more return suggestions comprises:
for each social return suggestion of said one or more social return suggestions, responsive to said cost value being lower than said cost value associated with all of said one or more physical return suggestions, presenting, to said first profile, said social return suggestion.

5. The computer-implemented method of claim 1, further comprising:
determining a social relationship database; and
determining a return availability database;
wherein said social return availability database is determined based on said social relationship database and said return availability database.

6. The computer-implemented method of claim 5, further comprising:
identifying a selected return suggestion; and
creating a reference to said selected return suggestion in said return availability database.

7. The computer-implemented method of claim 5, where determining said social relationship database further comprises:
accessing at least one social networking application programming interface.

8. A computer program product, comprising one or more computer readable storage media and program instructions stored on said one or more computer readable storage media, said program instructions comprising instructions to:
identify a return item, said return item being associated with a return item location;
identify a first profile, said first profile being associated with said return item and a social return availability database;
determine one or more return suggestions based on said return item location and one or more additional profiles of said social return availability database, wherein said one or more return suggestions suggest returning said return item by said one or more additional profiles; and
present, to said first profile, said one or more return suggestions.

9. The computer program product of claim 8, wherein said instructions to identify said return item further comprise instructions to:
receive a return request.

10. The computer program product of claim 8, wherein said one or more return suggestions comprise one or more delivery options selected from the group consisting of:
one or more social return suggestions; and
one or more physical return suggestions.

11. The computer program product of claim 10, wherein said program instructions further comprise instructions to:
for each of said one or more return suggestions, determine a cost value; and
for each social return suggestion of said one or more social return suggestions, determine whether said cost value is lower than said cost value associated with all of said one or more physical return suggestions; and
wherein said instructions to present said one or more return suggestions comprises:
for each social return suggestion of said one or more social return suggestions, responsive to said cost value being lower than said cost value associated with all of said one or more physical return suggestions, present, to said first profile, said social return suggestion.

12. The computer program product of claim 8, wherein said program instructions further comprise instructions to:
determine a social relationship database; and
determine a return availability database;
wherein said social return availability database is determined based on said social relationship database and said return availability database.

13. The computer program product of claim 12, wherein said program instructions further comprise instructions to:
identify a selected return suggestion;
create a reference to said selected return suggestion in said return availability database.

14. The computer program product of claim 12, wherein said instructions to determine said social relationship database further comprise instructions to:
access at least one social networking application programming interface.

15. A computer system comprising:
a processor;
one or more computer readable storage media;
computer program instructions;
said computer program instructions being stored on said one or more computer readable storage media; and
said computer program instructions comprising instructions to:
identify a return item, said return item being associated with a return item location;
identify a first profile, said first profile being associated with said return item and a social return availability database;
determine one or more return suggestions based on said return item location and one or more additional profiles of said social return availability database, wherein said one or more return suggestions suggest returning said return item by said one or more additional profiles; and
present, to said first profile, said one or more return suggestions.

16. The computer system of claim 15, wherein said one or more return suggestions comprise one or more delivery options selected from the group consisting of:
one or more social return suggestions; and
one or more physical return suggestions.

17. The computer system of claim 16, wherein said computer program instructions further comprise instructions to:
for each of said one or more return suggestions, determine a cost value; and
for each social return suggestion of said one or more social return suggestions, determine whether said cost value is lower than said cost value associated with all of said one or more physical return suggestions; and
wherein said instructions to present said one or more return suggestions comprises:
for each social return suggestion of said one or more social return suggestions, responsive to said cost value being lower than said cost value associated with all of said one or more physical return suggestions, present, to said first profile, said social return suggestion.

18. The computer system of claim 15, wherein said computer program instructions further comprise instructions to:
determine a social relationship database; and
determine a return availability database;
wherein said social return availability database is determined based on said social relationship database and said return availability database.

19. The computer system of claim 18, wherein said computer program instructions further comprise instructions to:
identify a selected return suggestion; and
create a reference to said selected return suggestion in said return availability database.

20. The computer system of claim 18, wherein said instructions to determine said social relationship database further comprise instructions to:
access at least one social networking application programming interface.
